(19) United States
(12) Patent Application Publication
(10) Pub. No.: US 2012/0323716 A1
(43) Pub. Date: Dec. 20, 2012

(54) System for Production, Distribution and Promotion of Performance Recordings

(76) Inventor: Demitrius Matthews, Excelsior, MN (US)

(21) Appl. No.: 13/477,233

(22) Filed: May 22, 2012

Related U.S. Application Data
(60) Provisional application No. 61/498,261, filed on Jun. 17, 2011.

(51) Int. Cl. G06F 15/16; G06Q 30/06

(52) U.S. Cl. 705/26.1; 709/217

(57) ABSTRACT

A system for performance production, distribution and promotion is provided. The system includes a recording phase that may take place in a permanent or mobile recording studio. With the assistance of an operator, an artist creates a recording of a performance, which may include audio-video effects as desired. The recording is then transmitted to the system website where it will be sorted into an artist's member directory. Artists can sign-in to the website to publish their works on an associated member page. Published works are available for website visitors to playback and purchase. Members of the website can communicate with each other and post upcoming events and recording releases to the community and to the public. Thus the system facilitates the production, distribution and promotion of new and undiscovered artists and encourages the growth of the artist community as a whole.

### CROSS REFERENCE TO RELATED APPLICATION

The present application claims the priority of U.S. provisional patent application No. 61/498,261, filed on Jun. 17, 2011 entitled “Portable Music Studio.”

### BACKGROUND OF THE INVENTION

1. Field of the Invention

The present invention relates to a system for production, distribution and promotion of performance recordings. Users of the system can create professional quality recordings of performances, distribute the recording in a number of ways, and promote and sell their recordings online via a system website. The convenience of a system that encompasses the entirety of the performance production and promotion process will be appreciated by new artists and artists who lack the resources or technical knowledge to produce and promote their own works.

The music recording industry is a complex field comprising a small amount of large well-founded companies and a large number of small independent businesses. These businesses and companies perform services in recording and production, distribution, and promotion and sales. The complexity of the associated processes makes it difficult for new artists to succeed without outside assistance. This assistance generally comes from at least one of a manager, a promoter and an entertainment lawyer. Understandably the guidance provided by such professionals may be beyond the financial resources of many new artists. It may be even more difficult for performance artists who are not in a musical group; such as poets, actors, dancers and the like, because these forms of performance art do not traditionally bring in large returns and thus are not well represented within the recording industry.

Artists who are able to obtain time at a recording studio and produce an album, LP or EP may lack knowledge of distribution means. Often performance groups limit distribution to the selling of physical media at live performances or to ordering of the same off the group website. Neither of these means utilizes the potential of the Internet as a conduit for recording distribution. Additionally, sales of the recordings are limited to the number of physical copies produced and the audience that is exposed to the group through live performance and word of mouth. Promotion on the Internet brings far greater potential for exposure than individual live performances. But publishing a group website may not be enough to provide the exposure necessary for large increases in sales and fan base. A collective of artists online can work to promote individual and collaborative efforts, thus providing exposure to all artists involved without expenditure of significant resources on the part of any one artist or group. A system is needed that can facilitate production of recordings, distribution of those recordings and promotion of an artist, without the need for the artist to procure in depth knowledge of the processes of the recording industry. Furthermore, a system is needed that encourages collaboration and promotion by artists and promotes the artistic community.

2. Description of the Prior Art

The present invention provides a system for production, distribution and promotion of performance recordings. Users of the system create customized audio and video recordings that are then uploaded to a user-interactive website that facilitates distribution and sales of each user's performance works. Though various aspects of music production, distribution and sales are known in the art, the system is unique in that it encompasses the entirety of the musical production process from the recording of audio-visual tracks to distribution and sales of finalized recordings.

Sound recording booths are available with a wide variety of options. User controlled sound booths provide a personalized karaoke experience for one or more users. When a user enters the booth, he or she selects a song and any desired visual effects and then presses a button to begin the recording session. Chu et al, U.S. Pat. No. 6,086,380 discloses a karaoke sound booth featuring a control panel disposed within the booth so that users may adjust sound and video settings during the performance. There are no settings adjustment capability provided to persons outside the booth.

User autonomy over a recording session is not available with all sound booths. Some recording booths require the assistance of an engineer to control recording settings throughout a performance. Carley et al, U.S. Patent Application Publication No. 2007/0098368 discloses an engineer operated sound booth for recording live events. Users of the sound booth may select audio tracks to sing along with and video backgrounds for display during the performance. The user performs a song, dance or action inside the booth while the engineer remains outside, adjusting audio-visual settings as necessary. Both the sound booth of Chu and the sound both of Carley provide a user with the option of obtaining their recordings on removable media after the recording session is over. These booths represent singular elements in the music production process. They offer an artist convenience in recording a song or video but do not contemplate effective distribution of the recordings by providing media storage on the Internet and automatic upload of files to that storage space.

The mobility of some recording systems provides audio-video recording experiences to users who otherwise do not have access to the means of music production. The sound booth of Carley et al does not disclose specific mode of mobility but it is described as being mobile and intended for temporary, permanent or semi-permanent installation in a given location. Other recording studios are integrated into a transportation vehicle to effectuate maximum mobility. One such mobile recording studio is described in O'Connell, U.S. Patent Application Publication No. 2010/0134695. The recording studio is disposed within the back of a truck and has sufficient recording capabilities to capture a performance within the “stage area” of the studio. This performance is transmitted to a receiver, where the performance is projected onto a theater screen for viewing by an audience. The device is intended for the use of providing audiences with a theatrical experience despite a lack of traditional theatrical facilities. It does not contemplate intensive audio-visual effects manipulation capabilities like those offered by the present invention. Not all portable sound recording systems are as cumbersome as the O'Connell studio. Lubbers, U.S. Pat. No. 7,262,358 discloses a portable sound recording system having headphones, a microphone, a music production means and a round recording means. The system can be used and manipulated by a single user who sings into the microphone and receives feedback through the headphones. An external operator is not necessary to the proper functioning of the system. Single user systems such as this one suffer from the same drawbacks as the larger recording studios discussed above.

None of these systems or devices provides a user with means for distribution, marketing or sale of their recorded music. These systems and devices focus only on recording audio and video performances and provide no further function to a user once the recording process is complete. The present invention addresses the need for continued support to recording artists after the recording process is over by providing a variety of distribution means and a conduit for sales of an artist's recordings.

Music sales is a known concept within the recording industry. The preferred means of music distribution changed over the years as cd and record stores gave way to online music download websites. Companies such as Apple's (Tunes(™)) software and Amazon(™) offer music file downloads that users of the website can purchase singularly or by the album. In many cases, users may sample a shortened selection of a music file prior to purchasing it. This allows a user to evaluate the content and sound quality before making a decision about purchasing. Unlike the present invention, these websites do not offer an online community that facilitates peer evaluation and collaboration. The present invention includes a website portion that offers playback and sales of a variety of performance art recordings. The prior art is limited to musical recordings and audiobooks. It does not address the need for users to promote acting performances, video art and the like. Further, the present invention provides a community to users, where they can evaluate and comment on music of other artists and where collaboration albums can be formed amongst artists. These collaborative works can be sold on the website in a similar fashion to each artist's individual work. Additionally, the music download websites known in the art do not address the integration of the music recording process into the distribution and sales processes.

The prior art taken as a whole, fails to meet the needs of local artists and independent groups, who lack the connections and resources to record, produce and sell their works. The present invention provides performance recording means, distribution conduits and sales portals. It substantially diverges in design elements from the prior art and consequently it is clear that there is a need in the art for a system that encompasses the various aspects of the performance production process. In this regard the instant invention substantially fulfills these needs.

### SUMMARY OF THE INVENTION

In view of the foregoing disadvantages inherent in the elements of the performance production and sales process now present in the prior art, the present invention provides a new performance production system, wherein the same can be utilized for providing convenience for the user when producing, promoting and selling recorded artistic works.

The system provides a means for recording a performance, distributing digital copies of that performance and promotion of the same. A recording studio is provided in both a permanent installation and mobile installation implementation. Users can record musical performances, poetry readings, dance numbers, skits and more. Performers do not need to possess any particular technical skills because a system operator handles recording session set-up and monitoring. A variety of audio and visual effects can be applied during and after the recording session to create the look and feel desired by the performer. The artist then reviews the finished product with the operator.

Finalized recordings are available to an artist as files stored on a removable media such as a compact disc or flash drive. The recording files can also be sent to a designated email address and to the system website. Flexibility in distribution methods gives the user a number of options for sharing their art with friends, family and their fan community.

Files that are transmitted to the system website are placed into folders in a user's member directory. The artist can elect to publish or not publish each individual file. Published files are available for playback and purchase, to visitors of an artist's member page. Visitors can watch and listen to all of an artist's published works and purchase performances singularly or in collections. Proceeds from the purchase of performances are credited to the artist. This allows local artists to sell their music online with limited transactional costs. The system website also provides an online community where artists and visitors can interact. Events and recording releases can be posted on a member page or on group forums to promote an artist's performances. Visitors and members alike can share artist material through social networking websites. The system thus provides a way of cultivating and encouraging the artistic community and potential collaborative efforts.

It is therefore an object of the present invention to provide a new and improved system for performance production, distribution and promotion that has all of the advantages of the prior art and none of the disadvantages.

It is therefore an object of the present invention to provide a means for producing quality recordings of performances for users who lack the resources or technical expertise to produce their own works.

Another object of the present invention is to provide a mobile recording studio that facilitates recording of performances in areas that lack access to professional recording means.

Yet another object of the present invention is to provide an easy to use performance recording experience that is assisted by a skilled system operator

Still another object of the present invention is to provide a plurality of distribution options to artists so that their recorded works may be shared according to the artist preference.

Yet another object of the present invention is to provide a user with the option of direct uploading of recordings to a website or user email, alleviating the need for the user to manually manage file transfers.

A further object of the present invention is to provide a website for artists that encourages promotion of artistic works and the cultivation of the artistic community.

A still further object of the present invention is to provide a website that facilitates collaborative performance projects between users.

Another object of the present invention is to provide a means for individual users to sell and be compensated for their artistic works without the need for users to have any specialized sales or business knowledge.

Yet another object of the present invention is to provide a system that incorporates the duration of the performance production process from recording, through distribution, to sales and marketing.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 generally shows a flow chart of the permanent installation embodiment of the system. Progression through the system is shown from the recording phase, through distribution on the Internet, to the promotion and sales phase.

FIG. 2 generally shows a flow chart of the mobile studio embodiment of the system. Progression through the system is shown from the recording phase, through distribution on the Internet, to the promotion and sales phase.

FIG. 3 shows an exemplary flow chart of a user sign-in experience.

FIG. 4 shows a flow chart of audio-video recording of a user performance with operator-provided assistance.

FIG. 5 shows a perspective view of a user inside a recording booth performing a song. Outside the booth an operator monitors and manipulates sound and video settings.

FIG. 6 shows a flow chart of the finalization of a recording and the means by which a user receives a copy of the recording.

FIG. 7A shows a flow chart of recording distribution via the system's website.

FIG. 7B shows a flow chart of recording distribution via a user designated email address.

FIG. 8 shows an exemplary embodiment of the member interface of the system website.

FIG. 9 shows an exemplary flow chart of the sales module of the system website.

### DETAILED DESCRIPTION OF THE INVENTION

Reference is made herein to the attached drawings. Like reference numerals are used throughout the drawings to depict like or similar elements of the system for performance production, distribution and promotion. For the purposes of presenting a brief and clear description of the present invention, the preferred embodiment will be discussed as used for providing performing artists with a means for recording and promoting their artistic works. The figures are intended for representative purposes only and should not be considered to be limiting in any respect.

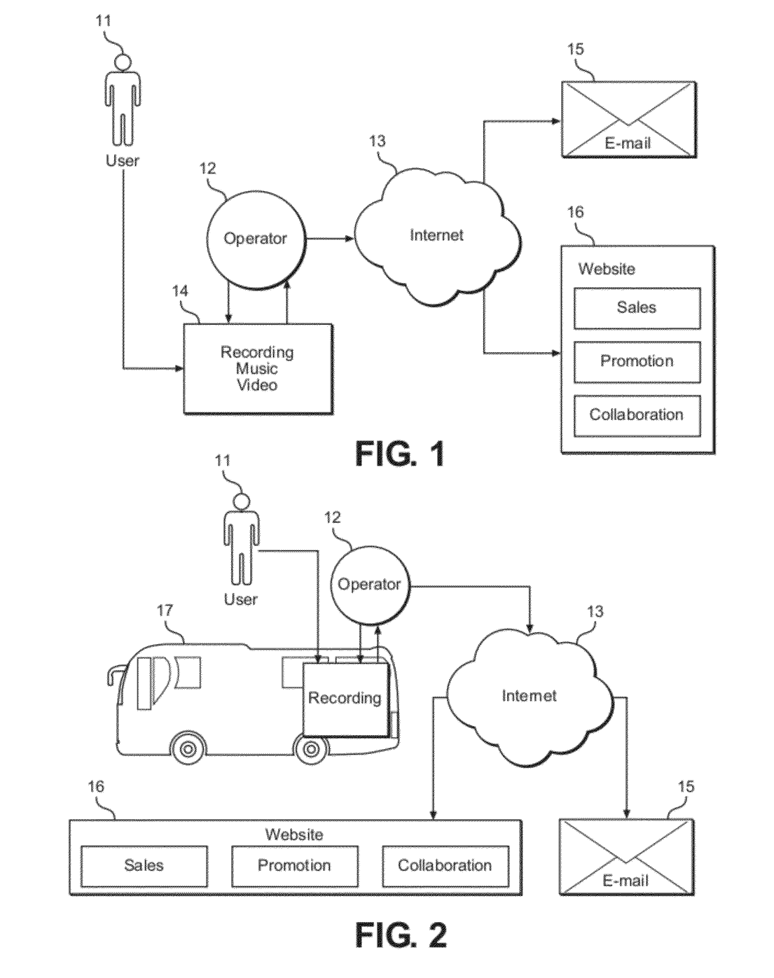

Referring now to FIG. 1, there is shown a flow chart of the system as a whole. The system comprises the recording of a performance 14, transmission of the recording through the internet 13, and promotion of the artists' works on a website 16. Users 11 of the system record songs and video with the assistance of an operator 12. This is generally done at a storefront where at least one recording booth is set up to record audio-video input. A user's preferences for sound and video settings are relayed to the operator stationed outside of the recording booth that monitors and adjusts recording settings. Once the performance is completed and the recording is finalized, it is given to the user on removable media or transmitted through the Internet to a user designated email address 15 or to the system website. The system website provides a number of features to facilitate the promotion of an artist's work including promotional events, sales and collaborative tools. Users can come individually or in groups to the recording studio storefront and produce high-quality audio-video recordings that they can then sell and promote online. In this manner, the system facilitates the production and promotion of small performing groups and local artists who may lack the resources or “know-how” to produce and promote their art.

Referring now to FIG. 2, there is shown a flow chart of an alternate embodiment of the system. Wherein the recording studio is mobile. In the mobile embodiment a user 11 records his performance in a recording studio installed within a mobile unit 17 such as a bus, truck, van or trailer. The operator 12 sits within the mobile unit but outside of the recording studio. As in the preferred embodiment, the operator monitors and controls recording 14 and transfers or transmits the finalized recording to the destination specified by the user. The mobile unit is capable of transmitting data across the Internet 13 to a user designated email address 15 or the system website 16. The mobile embodiment is advantageous because it allows the means of recording to be brought to events, parties, fairs and rural areas where users may lack access to music recording facilities. Promotion and scheduling of the mobile unit location may be done prior to its arrival to provide performance groups ample time to prepare for recording. This embodiment will be appreciated by local artists without regular access to recording facilities.

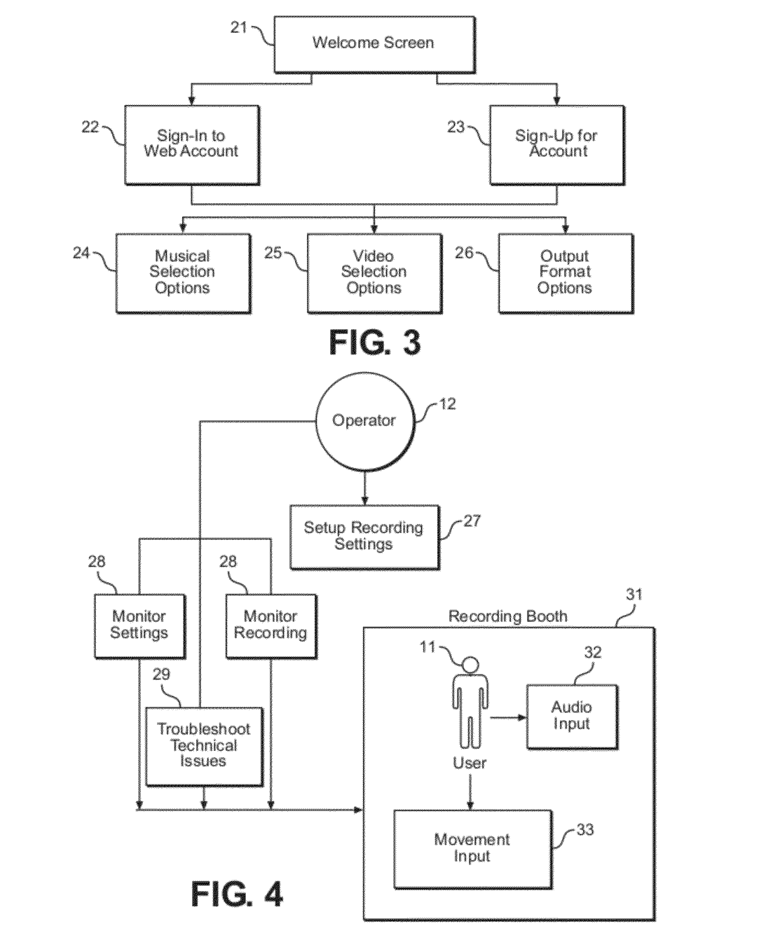

The recording aspect of the system generally begins at a kiosk, where a user can make selections pertaining to their recording session. In a storefront embodiment there might be a number of touchscreen kiosks or computer terminals spaced about the store to give groups room to consider the variety of available options. In FIG. 3 a flow chart of the sign-up process is illustrated. When a user approaches a kiosk he or she is greeted with a welcome screen 21. From the welcome screen, the user can sign-in 22 to the system website using their unique member ID and password. Upon authentication of the user's login information, the system will present the user's member settings. This can be particularly helpful to repeat users of the system, because settings may be retained to reduce the need for re-selection of recording options and output options at each recording session. If the artist does not have a system website account, they can sign-up 23 for one by providing the system with contact information and personalization preferences as prompted by the kiosk screen.

A multitude of recording session customization options is available to users during the sign-in process. These options include music selection 24, video selection 25, and output selection 26. At the music selection options screen, users can select a song they would like to sing along to, select to have vocals omitted from the sing along track, select any audio effects they wish to incorporate into the recorded track and other audio adjustments. Audio effects are well known in the sound production art by means such as fading, cross-fading, compression, phasing, reverb, phlanging, bit-crushing, delay, distortion and overdrive. It will be appreciated by system operators that such effects can be properly applied during or post-recording. In addition to audio effects, tracks may be mixed or blended to facilitate recording of multiple tracks in one session without undesirable breaks in the flow of music.

The video selection options 25 provide a user with choices regarding the look and feel of their video recording. A variety of stationary and dynamic background scenes are available to a user. Scenes may include clouds, a beachfront, the city at night, the interior of a club, light displays and the like. If users have a specific image or scene they brought with them, they can contact an operator to have the scene uploaded for use in the recording. Other options can include lighting level within the booth and digital video effects. As with the musical selections, some of these effects may be applied during recording and some may be applied after recording is complete.

Output options 26 provide a user with a list of available means for receiving the finished recording. In a preferred embodiment this screen will display a list of selectable choices, allowing the user to check off as many boxes as desired. The system operator can modify or change any options as necessary. It is desirable that the artist or group discuss their recording session with their operator prior to beginning the session, to discuss settings, the desired look and feel of the recording and what output options the artist requested.

Turning now to FIG. 4 there is shown a flow chart of a recording session. The system operator 12 performs the recording session set-up 27 based on options selected by the user at sign-in. If the user has additional requests or concerns about the recording process, the operator can adjust settings and options during set-up to address the user's concerns. The user then enters the recording booth 31 and recording begins. As audio input 32 and visual input 33 is provided by the user's performance, the operator monitors 28 sound and audio settings, adjusting them as needed to maintain audio-video quality. The operator can also trouble shoot technical issues 29 if any arise.

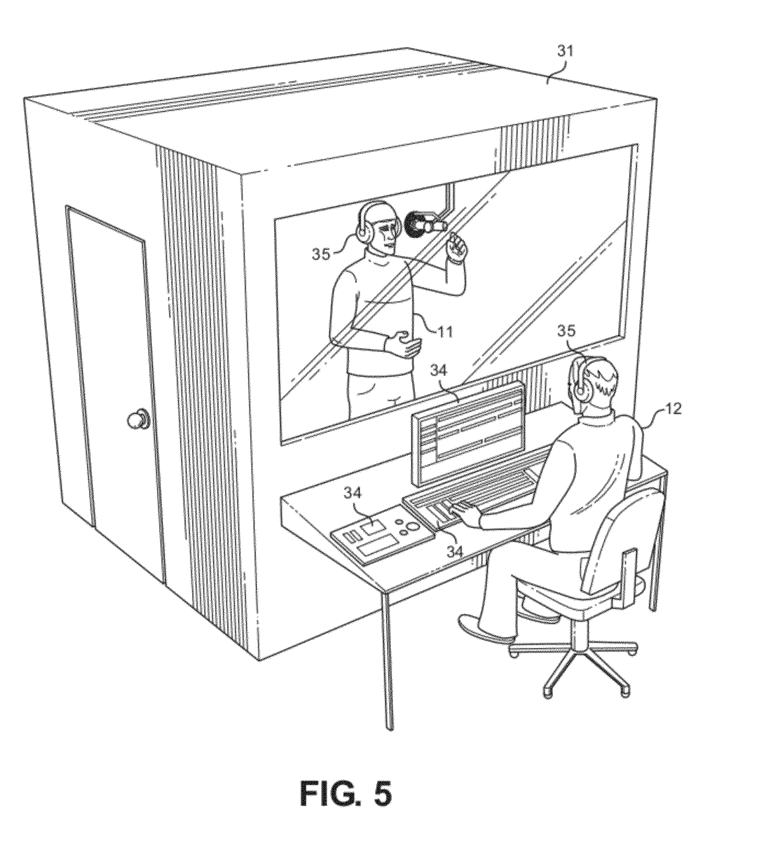

The recording session is displayed in a perspective view in FIG. 5, which depicts a user 11 inside the recording booth 31. During the artist's performance, the operator 12 remains outside at an operator terminal 34. Both the performer and the operator wear headphones or the like to cancel out background noise and provide feedback of the way the track sounds as it is recorded. This audio feedback in addition to the visual feedback provided by the operator terminal monitor, assists the operator with rapid response to adjustment of audio-video settings. In a preferred embodiment the recording booth is generally soundproof to prevent distraction to other artists preparing for recording sessions and to reduce sound pollution experienced during recordings.

The completion of the recording session is depicted in the flow chart of FIG. 5. Once a recording session is complete, post-production sound and video effects can be applied during recording finalization 41. During finalization, the operator 12 will apply effects and show the user the resulting recordings to assist the user in obtaining the desired sound and look for the recording. The operator then prompts 42 the user to confirm output selection choices and begins the conversion or transmission process 43. The recorded files may be provided to a user on a removable media 44 such as a compact disc, flash drive or Bluetooth device. From the removable media, the files can be imported to a media playback device 45 such as a CD player or computer with media playback software. The files may also be transmitted to a user designated email address 15 for a user to log in and pick up later 46; or the files can be transmitted to the system website 16, where a user can login and sort the files at a later time 47. There are a number of well-known and commonly used file types in the digital recording art. File types such as MP3, MP4, AVI, MPEG and the like, may be used. Methods of compressing and storing data change within the digital recording field over time and the present invention is not limited to specific types of files or storage media.

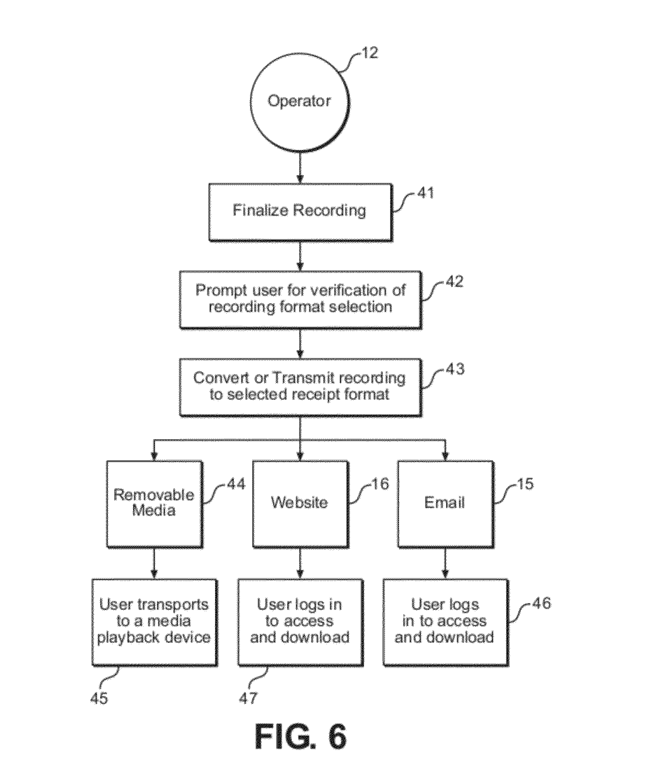

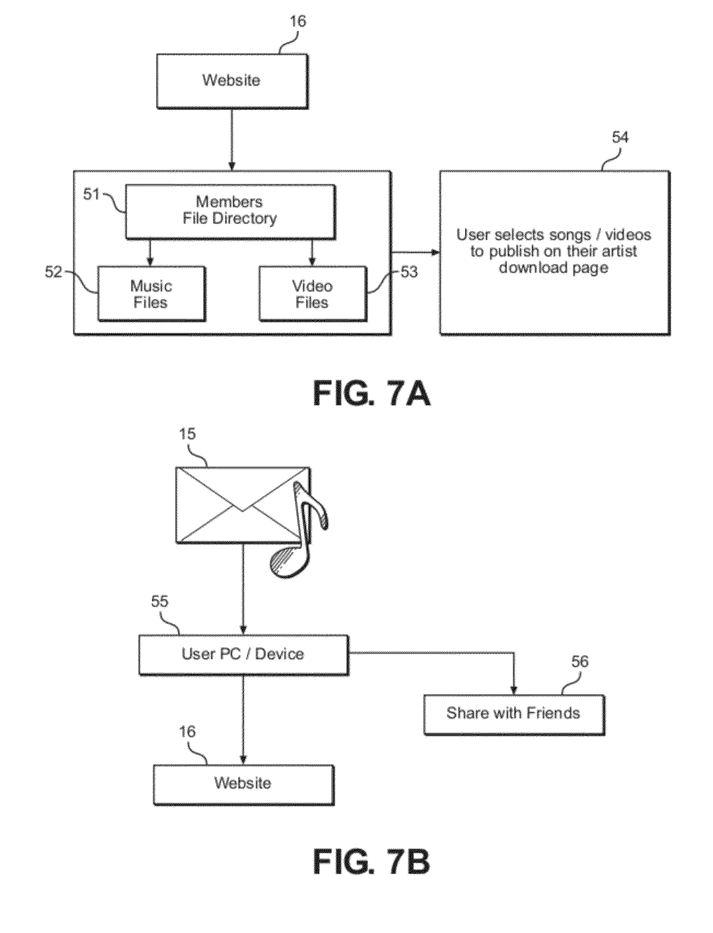

The recording distribution aspect of the system is shown in greater detail in FIGS. 7A and 7B. When a user selects the system website 16 as an output option, recording files will be uploaded by the operator (see FIG. 6). Recording files are stored in the user's member file directory 51, a storage space of predetermined size reserved for the specific member's files. The file directory that recordings are sent to is determined by the member id provided by the user at the sign-in and option selection stage (see FIG. 3). If a user creates a new member id at the sign-in stage, a member file directory is created during the generation of a new member account. In a preferred embodiment the system parses incoming files based on file extension/file type and sorts the files into a portion of the directory reserved for music files 52 and a portion for video files 53. This sorting routine organizes incoming recordings into two areas that are presented to a user as visually distinct folders in the user's file directory. Users who lack technical knowledge associated with file extension recognition and classification will appreciate the convenience provided by visual grouping of file types, which alleviates the need for the user to inspect files individually to determine their contents. Once a user accesses the new recordings he may select songs and videos to publish 54 on the website. These songs and videos will then become available for website visitors to sample and purchase. In an alternative embodiment incoming files are all stored within a single media folder.

Alternatively or in addition to website upload, users can select email 15 as a method of recording file receipt. Recording files will be sent to an email address specified by a user during the output options selection phase (see FIG. 3). Once the email is received, the user can download the files to his PC or other computing device 55. The downloaded files can be manually added to the user's member account on the system website 16. The system treats files uploaded to the website manually in the same manner as those sent directly to a user's file directory, for the purposes of publishing, promotion, sales and the like. If a user chooses not to add the recordings to the system website, the recordings can be shared 56 with friends, colleagues or any other party.

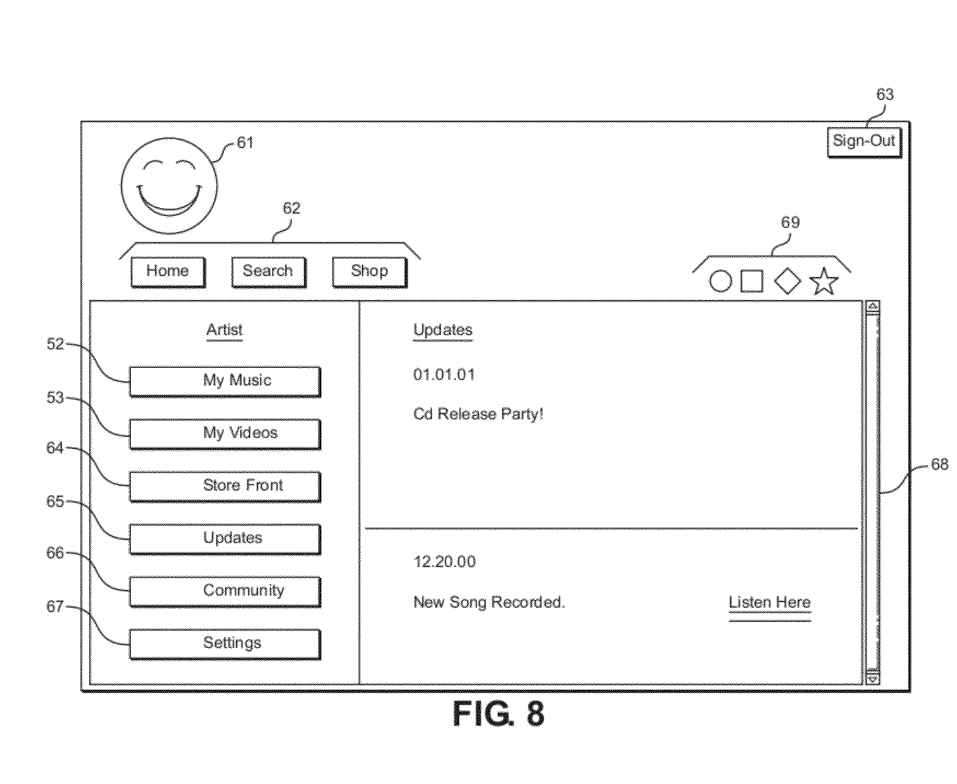

Referring now to FIG. 8, there is shown a screenshot of an exemplary embodiment of the system website's user interface. The website provides a means for users to manage their recording files, sell their works, promote themselves as an artist and collaborate with other artists. In a preferred embodiment the website is a membership based community website offering a customized experience to each user who signs-in to their account. The user interface displays generic information such as company logo 61, site navigation links 62 and the option to sign-out 63. Individually, artists have access to their music files 52 and video files 53 to playback, publish, or promote the recordings. Optionally, an images file folder may also be included to provide users with a place to store promotional materials, album art, performance photos and the like. The storefront facilitates the sale of an artist's recording and provides a means for managing transactions.

Upcoming performances, cd release announcements and artist appearances can be posted via the updates 65 link. By utilizing the community based nature of the website to provide a forum, the system provides users with a robust means of self-promotion. Updates are viewable to people who visit the artist's member page, the artist customized portion of the website that is accessible to the general public. Optionally, the website may also have a number of public forums of varying topics, where members can post promotional material. In this way the system provides non-member users with a means for obtaining information about local artist events in the user's area, thereby strengthening and promoting the local music scene. The community link 66 expands on the social facet of the system. At the community page, members can access member forums, search other member pages, send messages to other members, read FAQ/help documents and the like. By facilitating interaction between users, the system encourages them to sample each other's works, promote each other and engage in collaborative works. A number of social networking links 69 are arranged on each screen. Users may click on these links to share the page's content with friends on various social networking sites. Utilizing social networking sites is another way that users can promote their artistic works via the system.

A member-centric news feed 68 is displayed on the user interface. The news feed tracks updates posted by the member and any other members that have been selected for tracking. Members of the website can select other members to “track” in order to receive event notification, recording releases and other information about the artist. Users can change tracking settings as well as personal information, password and storefront options via the settings link 67. Membership based websites are known in the art in many varieties and it should be understood that the system website may be implemented in any language available in the art and in any layout or format desired.

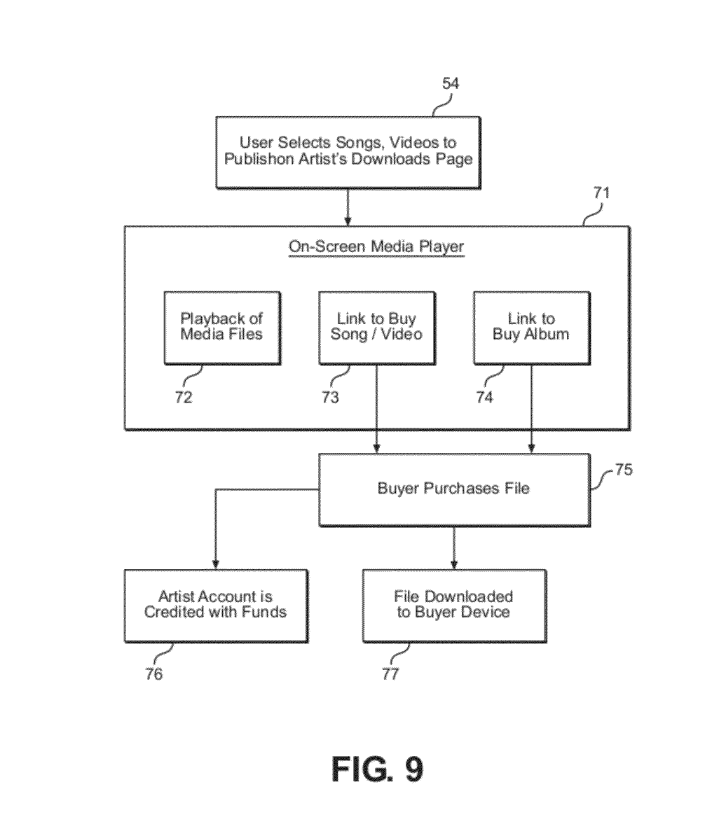

Turning now to FIG. 9, there is shown a flow chart of the sales page of the system website. From the member file directory users can select which recording files will be available to the public 54 (see FIG. 7A). Files selected for publication are loaded into an on-screen media player application 71. The application will provide visitors to the member's page with an interface for playback of media files 72, purchase a single song or video 73 or purchase an entire album 74. Song and video files should be organized within the application interface in a playlist style or grouped by type of file or by album. Purchase links may be placed in a noticeable location within the application interface such as next to each downloadable file, or in a single location. When a visitor selects a song or video from the list the media playback application will play the file. File output should be in a non-capturable format such as streaming media to reduce the potential for theft of intellectual property.

If the visitor decides to purchase a song, video or album, he selects the appropriate purchase link. In a preferred embodiment a checkout process will initiate within a new window, so media playback is not interrupted during purchase. The visitor buys the file 75 to complete the checkout process and the selected files are provided for download 77. Optionally, the checkout process can prompt a user for desired file format so that only desired file formats are presented to the user for download.

The artist's member account is credited 76 with the purchase price of the download, less transaction costs and commission. Artists can set up their preferred method of payment receipt within member settings. A bank account can be provided for direct deposit of funds to the artist. Alternatively, online payment accepting websites can be utilized, or a check can be issued to the artist from the company administering the system. The available sales options will be advantageous to artists who have gathered fans but lack the resources to gain a full time manager. The artist can benefit from distribution and sales of artistic works without the need for business acumen or sales knowledge.

The system is a means for production, distribution and promoting and selling artistic works. It offers new and “un-discovered” artists a means for creating recordings, publishing those recordings and promoting the artist or group. There is no single preferred technical implementation of the system. Implementation will require at minimum: a recording booth and associated operator terminal, a network connection associated with the operator terminal, at least one server to provide any of web-hosting, database access and/or file storage. These individual elements are known in the musical recording and web development arts. Multiple recording booths of varying types may be utilized in association with multiple operator terminals. More than one server may be used to implement elements individually or in groups. The system administrator(s) may choose the hardware implementation appropriate for their needs. Likewise, no specific software implementations are contemplated. The operator terminal should be outfitted with industry standard audio-video editing software or better. Database type, web-server software and the like may be selected at the implementer's discretion.

In use, a performing artist visits a storefront or mobile installation of the recording studio. The artist signs in to a system website account or signs up for an account if this is his first time using the system. After the artist is signed-in he can begin selecting options for the desired recording session. For example, the artist selects the song he wishes to sing to, decides to remove the normal vocal track so that only his vocals can be heard and then selects a few audio effects options. The artist can also select options for customizing the look of the recorded video. For example, a moving background depicting a club scene is selected and lighting levels are lowered. Output preferences are then selected and the options selection process is finalized.

The system operator receives the desired settings and sets up the recording booth and audio-visual recording software for the session. Artist enters the recording booth and prepares for the performance. Once the recording session begins, the artist performs the selected song. The operator then assists the artist in reviewing the recording. Sound and video effects that were not applied during recording can be applied in the post-recording phase. The recording is finalized and converted or transmitted into the artist-designated format. If the artist selected “audio cd” and “website upload” he will be given an audio cd copy of the recording and the associated file will be uploaded to the system website.

The artist then signs-in to the system website from a personal computing device or mobile device. The file will automatically be placed in an appropriate file folder based on the associated file extension. By selecting a “publish” option near the file link, the recording becomes available for playback on the artist's member page. Visitors to the artist's member page can play the song/video and purchase the file. Any purchases of artist works are credited to the artist's member account. To promote the new recordings, the artist posts an update to his newsfeed. He can also approach other artists through messaging to suggest a collaboration project to increase sales and publicity.

To this point, the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A system for production, distribution and promotion of performance recordings, comprising:
at least one recording booth, wherein each recording booth has an associated operator terminal adapted to monitor and manipulate recordings of performances made within said recording booth;
a network;
a database;
a web-server;
a website hosted on said web-server and having a plurality of individual user accounts;
said operator terminal is adapted to transmit recordings made in said recording booth over said network;
said web-server is adapted to receive recordings made in said recording booth from said network, store said recordings in said database and associate them with a user account.

2) The system of claim 1, wherein said recording booth is located within a motor vehicle or trailer assembly.

3) The system of claim 1, further comprising:
at least one user terminal adapted to prompt users to sign-in to a user account of said website, or generate a user account for said website;

4) The system of claim 3, wherein said user terminal is adapted to receive user input for recording session preferences.

5) The system of claim 4, wherein said recording session preferences comprises audio, video.

6) The system of claim 5, wherein said recording session preferences further comprises output media settings determine the media format in which a recording will be provided to a user.

7) The system of claim 6, wherein one of said output media settings is for transfer of a recording to a user account of said website that was entered at said user terminal.

8) The system of claim 6, wherein one of said output media settings is for transfer of said recording to a user designated e-mail address.

9) The system of claim 6, wherein one of said output media settings is for transfer of a recording to removable media.

10) The system of claim 1, wherein recordings associated with a user account by said web-server may be selected for publication on a webpage associate with the same user account.

11) The system of claim 10, wherein said webpage is adapted to provide playback of a recording by visitors to said webpage.

12) The system of claim 10, wherein said webpage is adapted to provide visitors with the ability to purchase a downloadable version of a recording.

13) The system of claim 12, wherein said website is adapted to credit a user account with an amount to be paid whenever a recording is purchased.

14) The system of claim 13, wherein amounts credited to a user account may be electronically transferred to a user bank account.

15) The system of claim 1, wherein said website further comprises for communication amongst users of said website.

16) The system of claim 1, wherein said website further comprises a news feed.

17) A system for production, distribution and promotion of performance recordings, comprising:
at least one recording booth, wherein each recording booth has an associated operator terminal adapted to monitor and manipulate recordings of performances made within said recording booth;
a network;
a database;
a web-server;
a website hosted on said web-server and having a plurality of individual user accounts;
at least one user terminal adapted to prompt users to sign-in to a user account of said website, or generate a user account for said website;
said operator terminal is adapted to transmit recordings made in said recording booth over said network;
said web-server is adapted to receive recordings made in said recording booth from said network, store said recordings in said database and associate them with a user account, and wherein said recordings may be selected for publication on a webpage associate with the same user account.

18) The system of claim 17, wherein said recording booth is located within a motor vehicle or trailer assembly.

19) The system of claim 17, wherein said webpage is adapted to provide visitors with the ability to playback a recording and purchase a downloadable version of a recording.
